(19) United States
(12) Patent Application Publication
(10) Pub. No.: US 2015/0106065 A1
(43) Pub. Date: Apr. 16, 2015

(54) Joining Imperfectly-Matching NURBS Patches To Form a Computerized Model Suitable For FEA

(71) Applicant: Livermore Software Technology Corporation, Livermore, CA (US)

(72) Inventor: Stefan Hartmann, Stuttgart (DE)

(73) Assignee: Livermore Software Technology Corporation, Livermore, CA (US)

(21) Appl. No.: 14/051,559

(22) Filed: Oct. 11, 2013

(51) Int. Cl. G06F 17/50

(52) U.S. Cl. CPC G06F 17/5018
USPC 703/2

(57) ABSTRACT

Techniques of joining imperfectly-matching NURBS patches to form a computerized model suitable for FEA are disclosed. Definitions of first and second patches are received for joining together along a physical boundary defined in first and second curves that are imperfectly-matching. Both curves' knot-vectors are normalized such that the parametric length equals the physical length, respectively. The curve having less number of control points is designated as master curve, the other as slave curve. If the curves are partially overlapped the first and second curves are adjusted such that first and second projection points correspond to starting and end locations of the common curve, respectively A set of linear constraint equations for numerically connecting the patches along the physical boundary by computing dependencies of the slave curve's control points to the master curve's control points. The patches together with the constraint equations enable a computerized model created therefrom suitable for FEA.

### FIELD

The present invention generally relates to computer-aided engineering analysis, more particularly to methods and systems for joining imperfectly-matching Non-Uniform Rational Basis Splines (NURBS) patches to form a computerized model suitable for Finite Element Analysis (FEA).

### BACKGROUND

With advance of computer technology, computer aided engineering (CAE) and computer aided design (CAD) have been used for helping engineers/scientists to design products in various industries (e.g., automotive, aerospace, etc.). One of the first developed CAE technologies is finite element analysis (FEA), which is a computerized method widely used in industry to model and solve engineering problems relating to complex systems such as three-dimensional non-linear structural design and analysis. FEA derives its name from the manner in which the geometry of the object under consideration is specified.

The FEA software is provided with a model of the geometric description and the associated material properties at each point within the model (sometimes referred to as a FEA mesh model). In this model, the geometry of the system under analysis is represented by solids, shells and beams of various sizes, which are called elements. The vertices of the elements are referred to as nodes. The model is comprised of a finite number of elements, which are assigned a material name to associate the elements with the material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

Furthermore, an industry referred to as computer-aided design (CAD) was developed for representing geometry of a product such as surface modeling. In CAD, mainly NURBS based curves and surfaces are used. In general, a product's design is encapsulated in a CAD system and the FEA mesh model is generated from the CAD data. As a result, the FEA mesh model is represented by approximated geometry of the product. Generation of such FEA mesh model is generally performed with semi-automatic manners. To overcome these shortcomings, a NURBS-based FEA was developed.

Owing to different requirements in CAD and FEA, there are drawbacks associated with NURBS-based FEA. One of which is related to trimmed NURBS surface description. In particular, a trimmed NURBS surface comprises an underlying regular NURBS surface with additional trimming lines that define the portions of the underlying surface patch to be displayed or not. While the trimmed NURBS works fine in CAD, its use in FEA is a current topic in research and not state of the art yet. Instead of using the original trimmed NURBS representation directly, it will be cut down into a set of smaller regular NURBS patches first. Then a new set of NURBS parameters must be created for the smaller regular NURBS patches to be suitable for FEA (e.g., maintaining continuity at the patch boundaries). However, to create a new set of NURBS parameters is a tedious and difficult task.

Therefore, it would be desirable to have improved methods and systems for joining imperfectly-matching Non-Uniform Rational Basis Splines (NURBS) patches to form a computerized model suitable for Finite Element Analysis (FEA).

### SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Systems and methods of joining imperfectly-matching Non-Uniform Rational Basis Splines (NURBS) patches to form a computerized model suitable for Finite Element Analysis (FEA) are disclosed. According to one aspect, definitions of first and second NURBS patches are received in a computer system. First and second NURBS patches are to be joined together along a physical boundary, which is defined in a first curve in the first patch with a first set of control points with associated weights and a corresponding first knot-vector and, is defined in a second curve in the second patch with a second set of control points with associated weights and a corresponding second knot-vector. The first curve and the second curve are defined with different control points, weights and knot-vectors. Both curves' knot-vectors are normalized such that the parametric length equals the physical length, respectively.

A common curve representing the physical boundary is determined. The common curve can be an overlapped section between the first curve and the second curve. Then the first and second curves knot-vector values are adjusted (e.g. scaled and shifted) in such a way that: setting u=0 would yield projection point \hat{P}ₐ¹ and setting u=L_{c}, would yield projection point \hat{P}_{b}² (See FIGS. 7C-7E). The curve having less number of control points in the overlapped section is designated as master curve, the other as slave curve.

A set of linear constraint equations for numerically connecting the first and second NURBS patches along the physical boundary by computing dependencies of the slave curve's control points to the master curve's control points. The patches together with the set of constraint equations along the physical boundary enable a computerized model created therefrom suitable for FEA.

According to another aspect, the dependencies are determined using virtual insertion and virtual removal techniques between the master and the slave curves or alternatively using the pseudo-inverse of S shown in FIG. 7F.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-1C collectively is a flowchart illustrating an exemplary process of joining imperfectly-matching Non-Uniform Rational Basis Splines (NURBS) patches to form a computerized model suitable for Finite Element Analysis (FEA), according to an embodiment of the present invention;

FIG. 2 is a diagram showing exemplary NURBS patches joined together along a physical boundary in accordance with one embodiment of the present invention;

FIGS. 3A-3B are diagrams showing exemplary partially overlapped NURBS patches according to an embodiment of the present invention;

FIG. 4 is a plan view showing two exemplary imperfectly-matching NURBS patches with their associated control points and knot-vector, according to an embodiment of the present invention;

FIGS. 5A-5C are diagrams showing an exemplary creation of control point dependency in accordance with an embodiment of the present invention;

FIGS. 6A-6B are diagram showing an exemplary computerized model that is created using the exemplary process shown in FIGS. 1A-1B, according to an embodiment of the present invention;

FIGS. 7A-7F are a series of diagrams showing imperfectly-matching NURBS patches joined together with an exemplary method in accordance with one embodiment of the present invention; and

FIG. 8 is a function block diagram showing salient components of an exemplary computer system, in which one embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

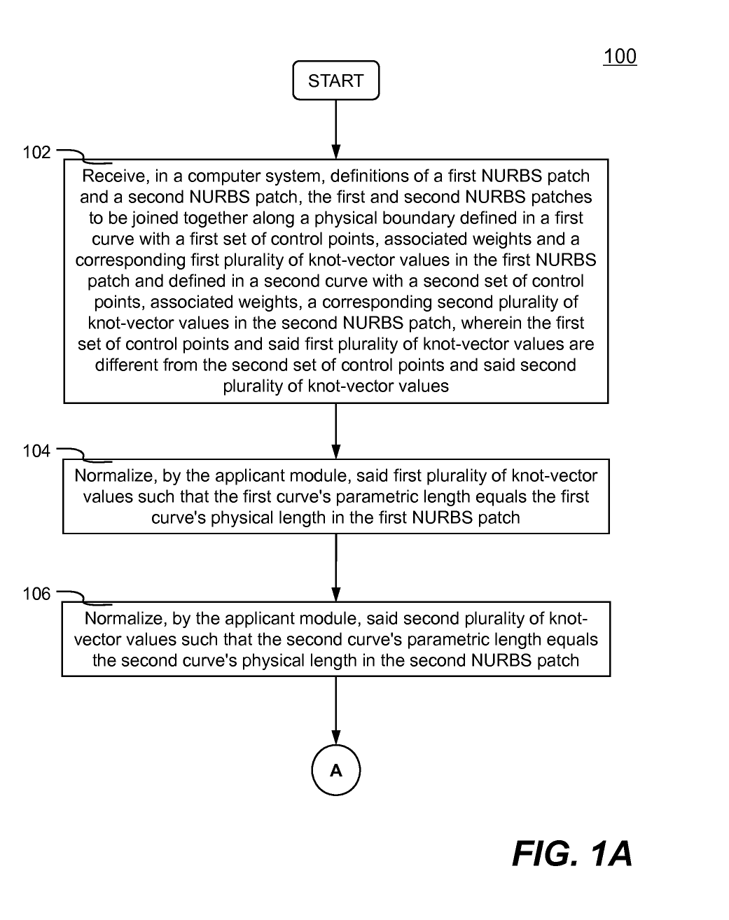

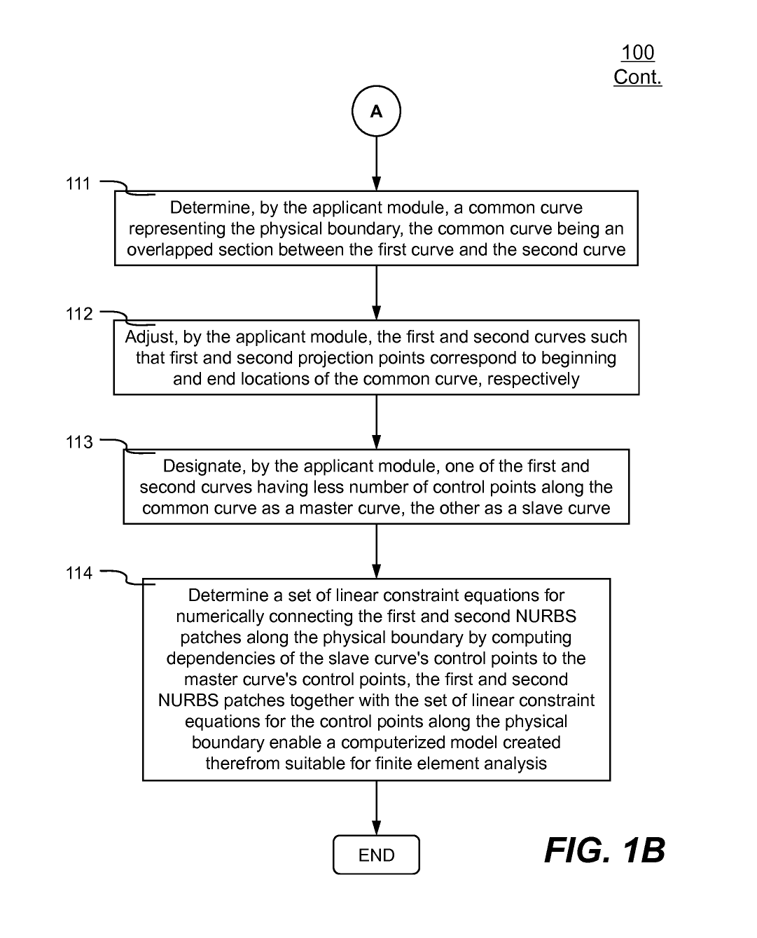

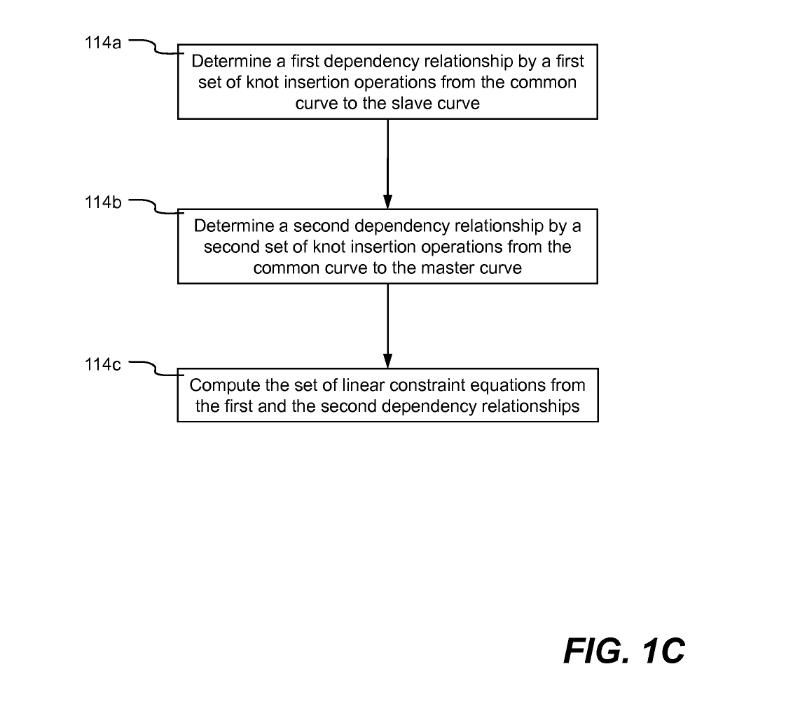

Embodiments of the present invention are discussed herein with reference to FIGS. 1A-8. However, those skilled in the art will readily appreciate that the detailed description given herein with respect to these figures is for explanatory purposes as the invention extends beyond these limited embodiments.

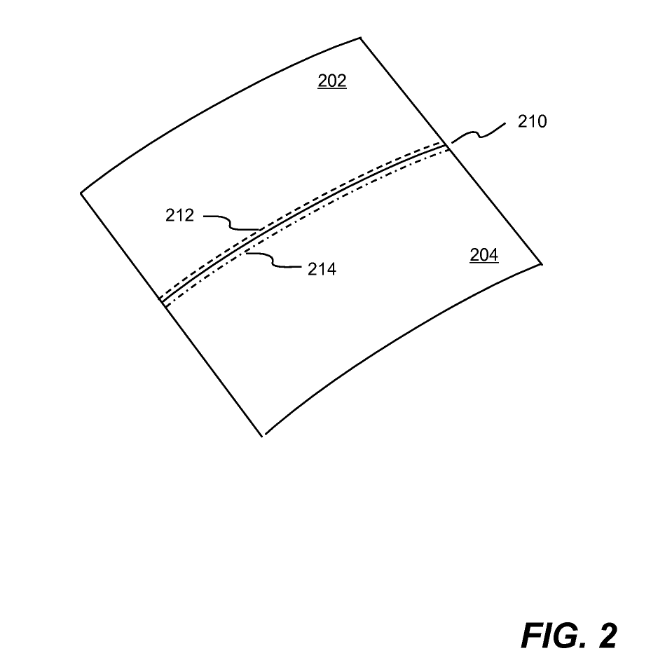

Referring first to FIGS. 1A-1C, there are collectively shown a flowchart illustrating an exemplary process 100 of joining imperfectly-matching Non-Uniform Rational Basis Splines (NURBS) patches to form a computerized model suitable for Finite Element Analysis (FEA) in accordance with one embodiment of the present invention. Process 100 is preferably implemented in software and understood with other figures, for example, FIGS. 2-8.

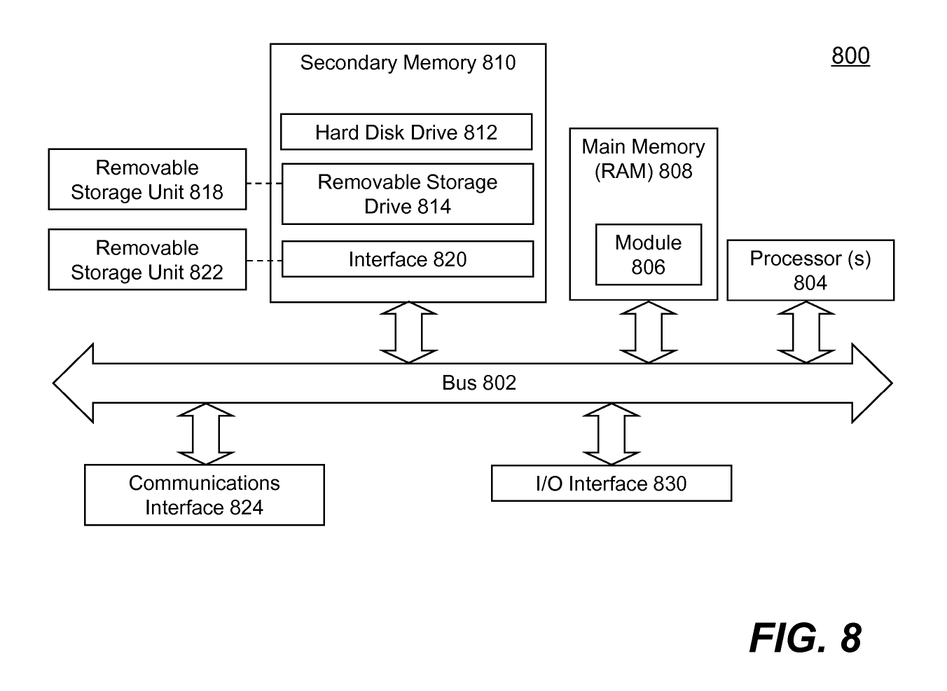

Process 100 starts at step 102 by receiving definitions of first and second NURBS patches in a computer system (e.g., computer system 800 of FIG. 8) having an application module installed thereon. The application module can be software for creating a NURBS-based FEA computerized model. Sometimes, software used for such a purpose may be referred to as pre-processor (for pre-processing an input file to become suitable for engineering analysis (e.g., FEA)). The first and second NURBS patches 202-204 are to be joined together along a physical boundary 210 (e.g., a physical curve or a commonly shared curve) shown in FIG. 2. The physical boundary 210 is defined in a first curve 212 in the first NURBS patches 202 and in a second curve 214 in the second NURBS patch 204. The first curve 212 is represented by a first set of control points, their associated weights and corresponding first set of knot-vector values, while the second curve 214 is represented by a second set of control points, their associated weights with corresponding second set of knot-vector values. According to one aspect of the invention, the first curve 212 and the second curve 214 are defined differently but represent within a certain tolerance the same physical boundary 210. In other words, the first curve 212 and the second curve 214 are partially-matched or imperfectly-matched. The tolerance can be either specified by a user of the application module or defined internally in the application module with known methods.

Next, at step 104, the knot-vector values of the first curve are normalized such that the parametric length equals its physical length. Similarly, at step 106, the knot-vector values of the second curve are normalized. One exemplary procedure of normalizing a curve is to evaluate the physical length of the curve (e.g., by numerical integration) first, then the knot-vector representing the curve is scaled in such a way that the difference between the first and the last knot-vector value matches the physical length.

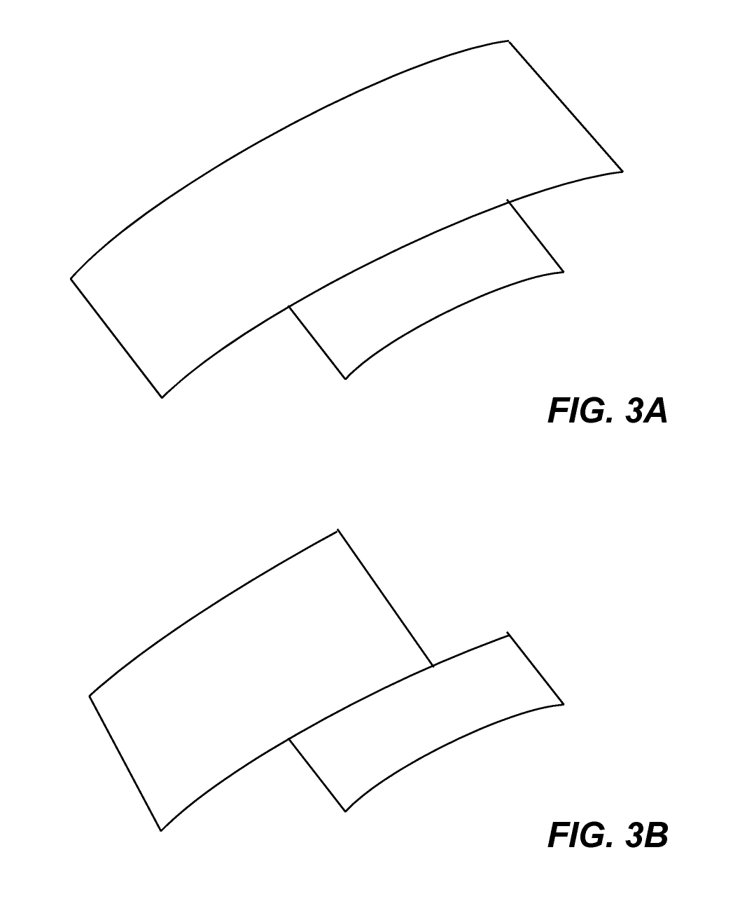

At step 111, a common curve (or commonly shared curve) representing the physical boundary is determined. The common curve can be an overlapped section between the first and the second curves. Two exemplary partially-overlapped NURBS patches are shown in FIGS. 3A-3B.

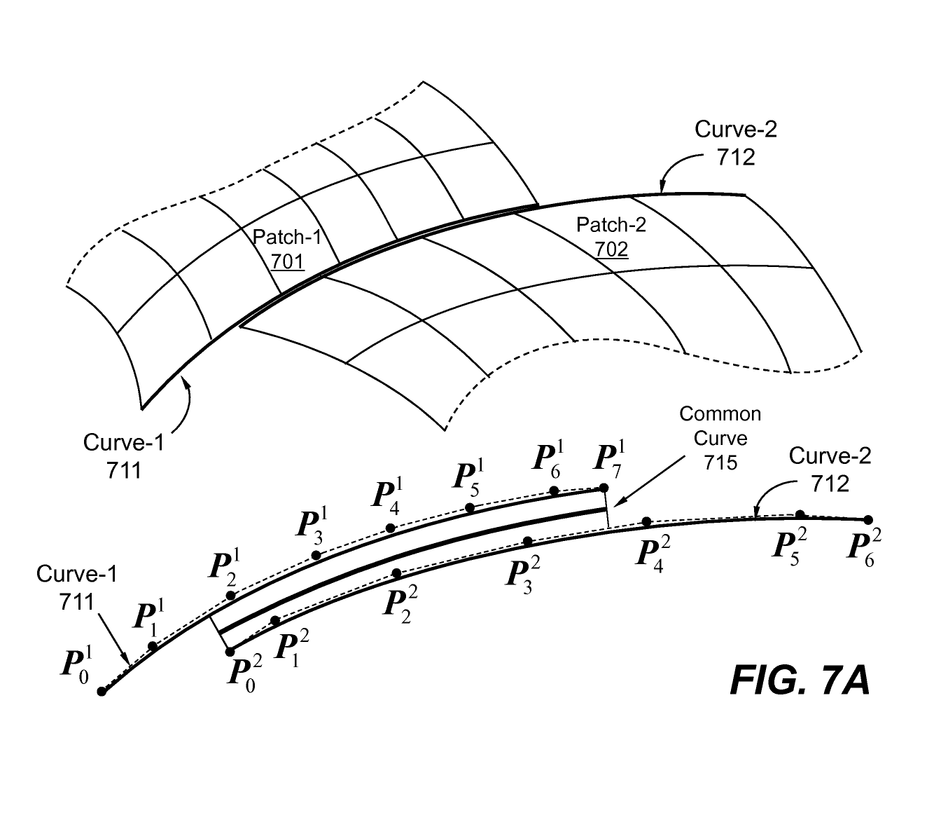

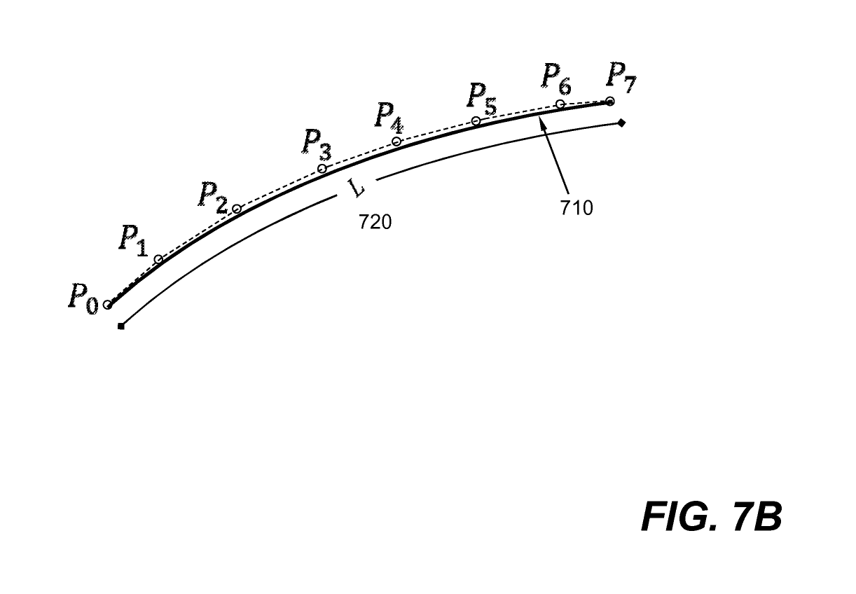

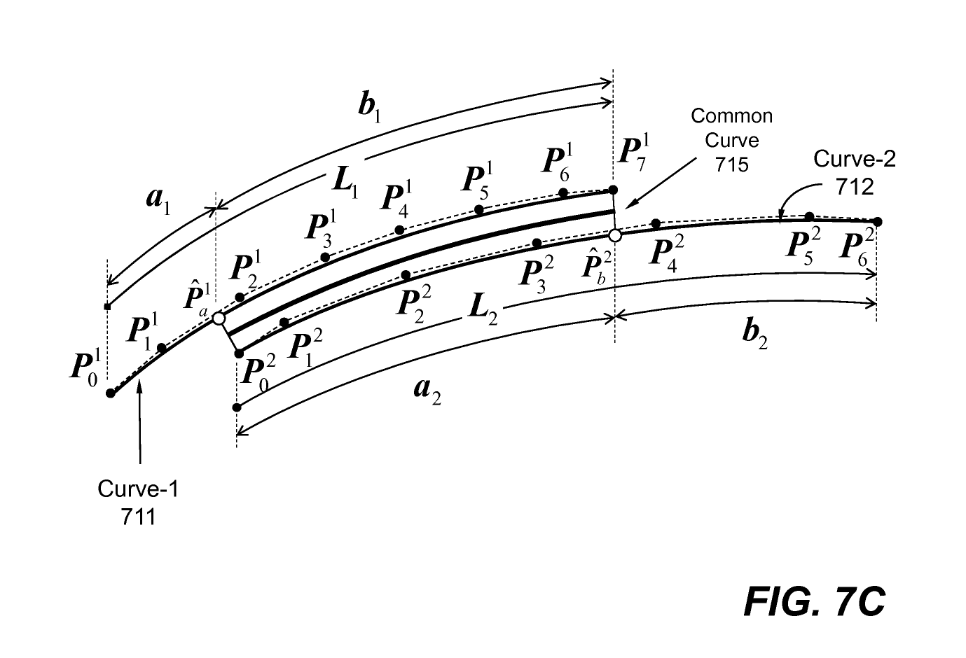

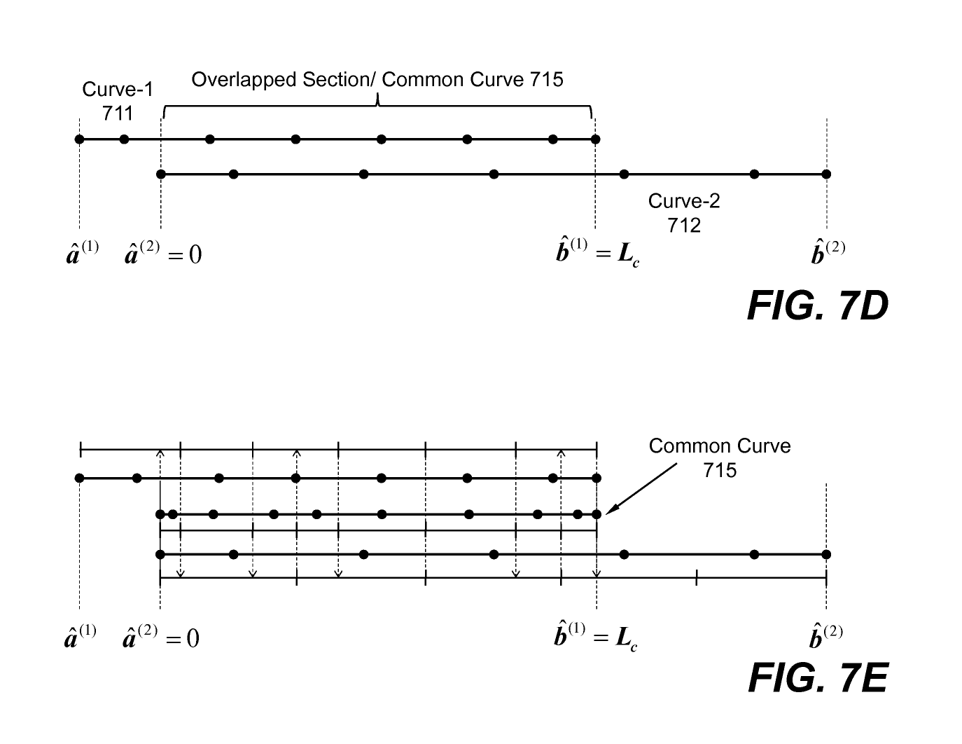

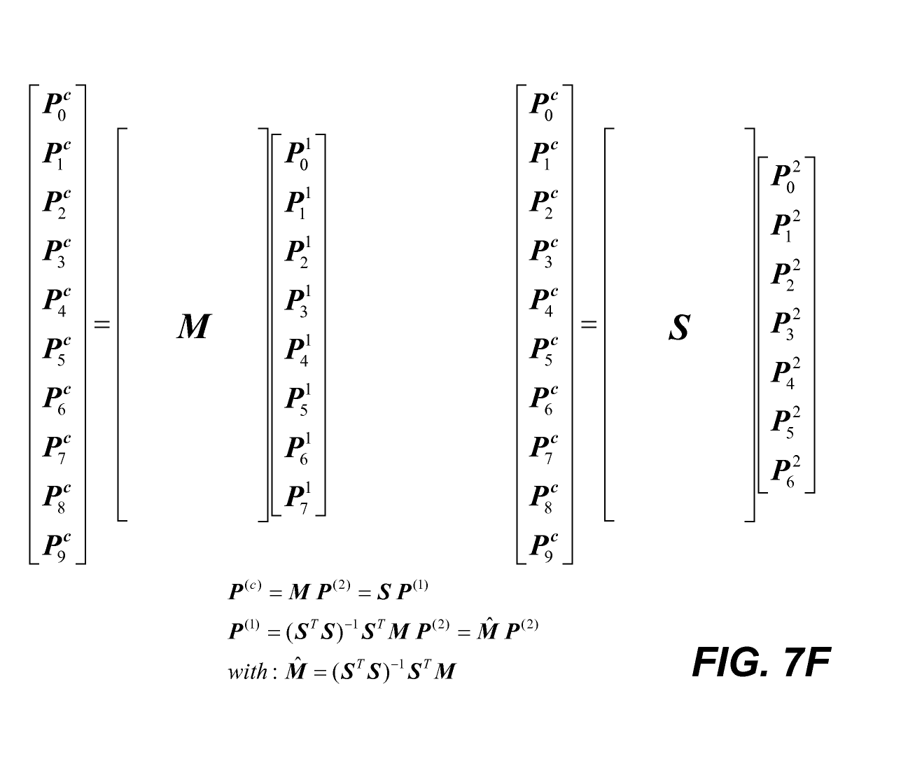

Then, at step 112, the first and second curves knot-vector values are adjusted (e.g., scaled and shifted) in such a way that: setting u=0 would yield projection point \hat{P}ₐ¹ and setting u=L_{c} would yield projection point \hat{P}_{b}² (See FIGS. 7C-7E). In other words, as a result of the adjustment, first and second projection points correspond to starting and end locations of the common curve, respectively.

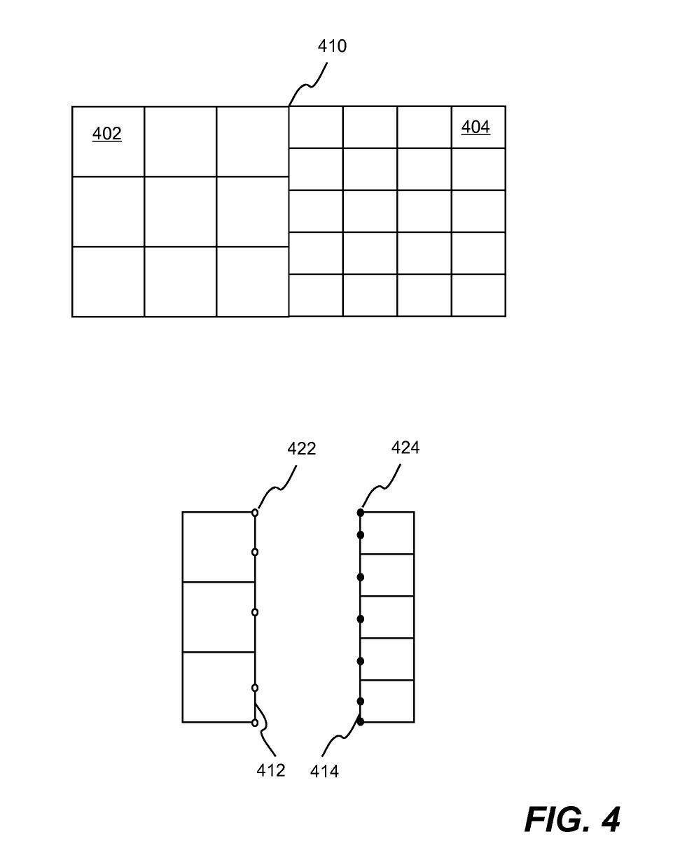

Next step 113, one of the first and second curves having less number of control points along the overlapped section is designated as a master curve, the other as a slave curve. FIG. 4 is a plan view showing two exemplary NURBS patches 402-404 joined together along a physical boundary 410 with first curve 412 and second curve 414, respectively. The first curve 412 is defined by a first set of control points 422 (hollow dots) while the second curve 414 is defined by a second set of control points 424 (solid dots). The first curve 412 is designated as master curve and the second curve 414 is designated as a slave curve, because there is less number of control points in the first curve 412.

Finally, at step 114, a set of linear constraint equations for numerically connecting the first and second NURBS patches along the physical boundary is determined. The constraint equations are based on dependencies between the control points of the master curve (independent control points) and the control points of the slave curve (dependent control points). Using the set of constraint equations to restrict the displacement of the slave curve to the master curve, the first and the second NURBS patches can deform in unison along the common physical boundary. The dependency can be computed as follows: determining a first dependency relationship by performing a first set of one or more knot-vector insertion operations from the common curve to the slave curve at step 114a; determining a second dependency relationship by performing a second set of one or more knot-vector insertion operations from the common curve to the master curve at step 114b; and computing the linear constraint equations from the first and the second dependency relationships at step 114c.

The first and second NURBS patches together with the constraint equations for the control points along the physical boundary enable the computerized model created there from suitable for finite element analysis.

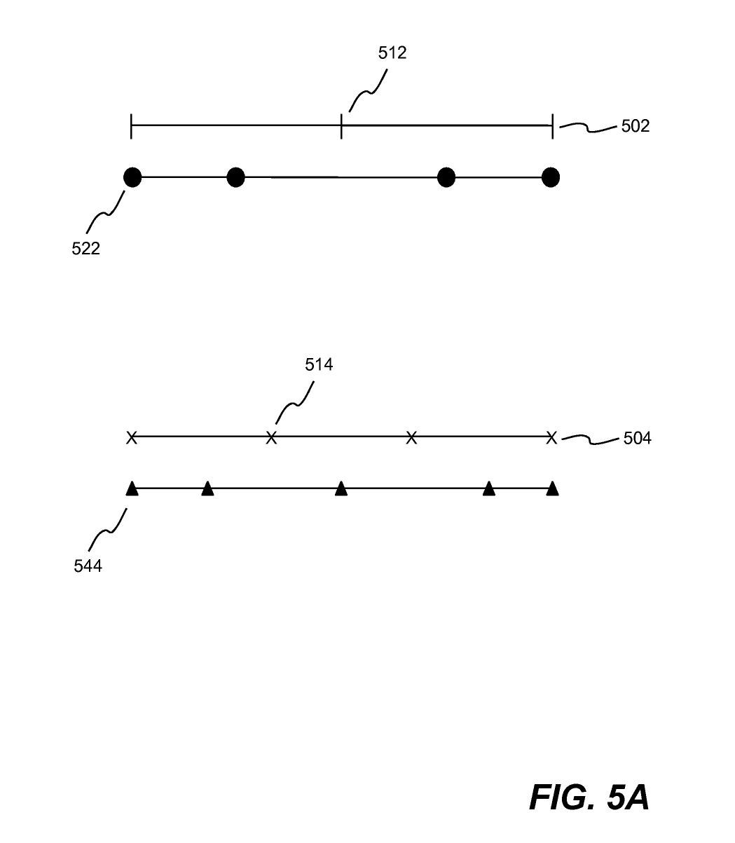

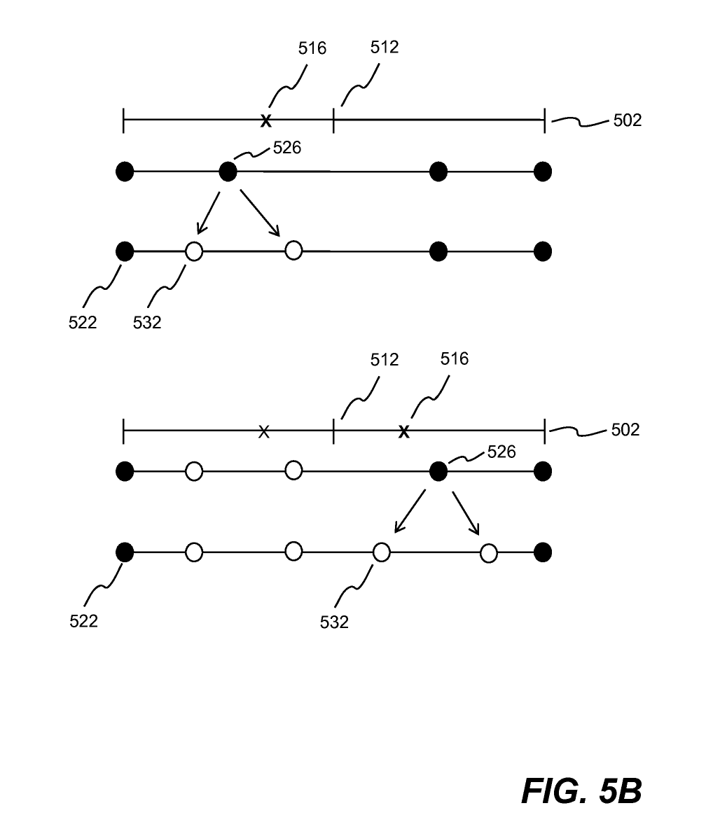

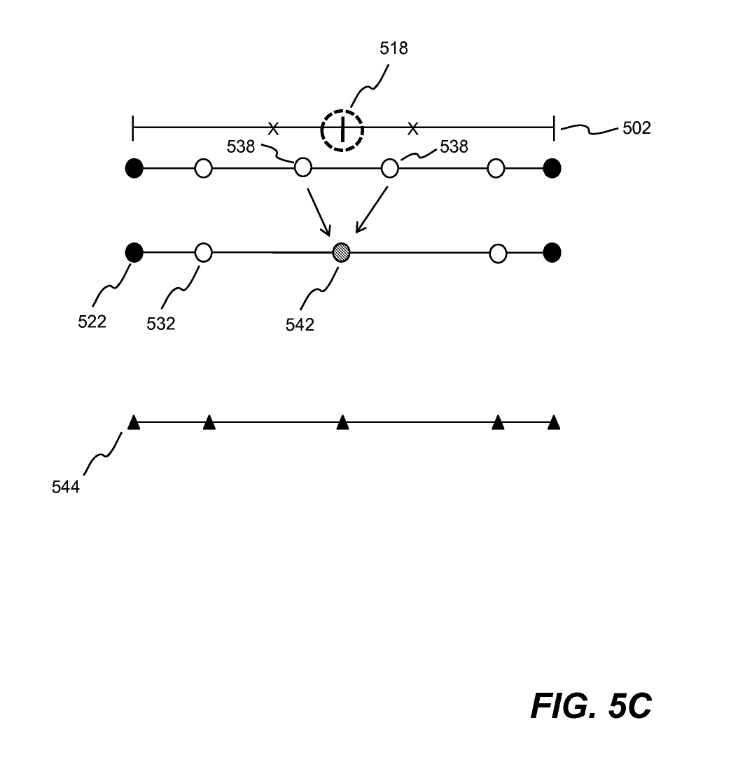

To demonstrate how the dependencies are computed, a series of figures are shown in FIGS. 5A-5C. Shown in FIG. 5A, a master curve 502 is defined by a set of master control points 522 (shown as circular dots) and corresponding knot-vector values 512 (shown as “|”), and a slave curve 504 is defined by a set of slave control points 544 (shown as triangles) and corresponding knot-vector values 514 (shown as “X”). To determine the dependencies of the slave curve's control points 544 to the master curve's control points 522, it is a two-step procedure: virtual knot-vector value insertion and virtual knot-vector value removal.

In a virtual knot-vector insertion procedure, any of the slave curve's knot-vector values that is not already included in the master curve's knot-vector is virtually inserted into the master curve's knot-vector. Dependencies of virtually inserted knot-vector values are computed. FIG. 5B shows the slave curve's knot-vector values 516 that are not already included in the master curve are inserted into the master curve 502. Corresponding control points 526 for the inserted knot-vector values 516 are converted into new control points 532 (shown as hollow circles). In this example, there are two slave curve's knot-vector values 516 that are not already in the master curve. Other numbers of control points can exist for other situations.

After the virtual knot-vector insertion has been performed, a knot-vector removal is performed for removing any of the master curve's knot-vector values that is not in the slave curve. Dependencies of virtually removed knot-vector values are computed thereafter. Shown in FIG. 5C, a knot-vector value 518 is removed, and two corresponding control points 538 are converted into one control point 542 (shown as a grey circular dot). It is noted that the knot-vector value 518 does not exist in the slave curve. The resulting master curve's control points 522, 532, 542 are the same as the slave curve's control points 544.

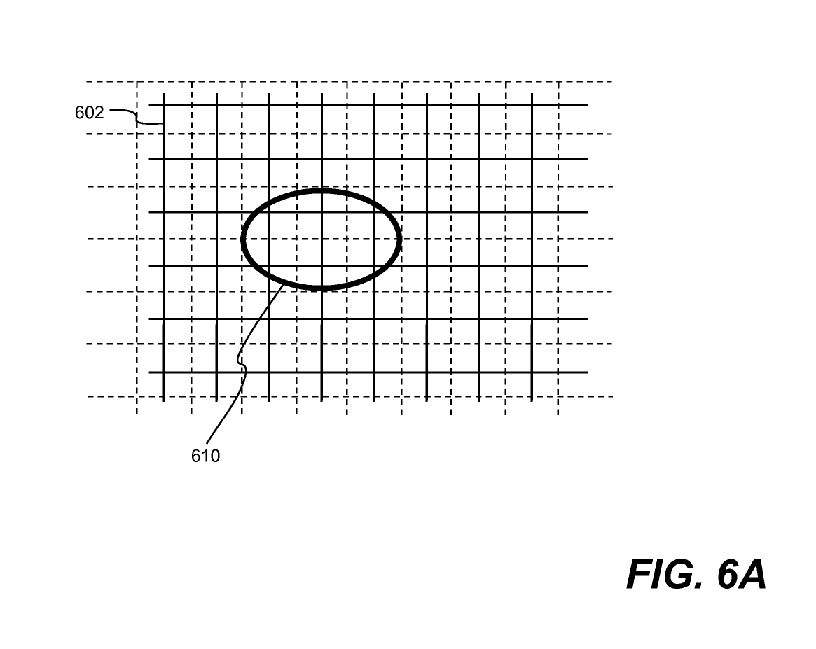

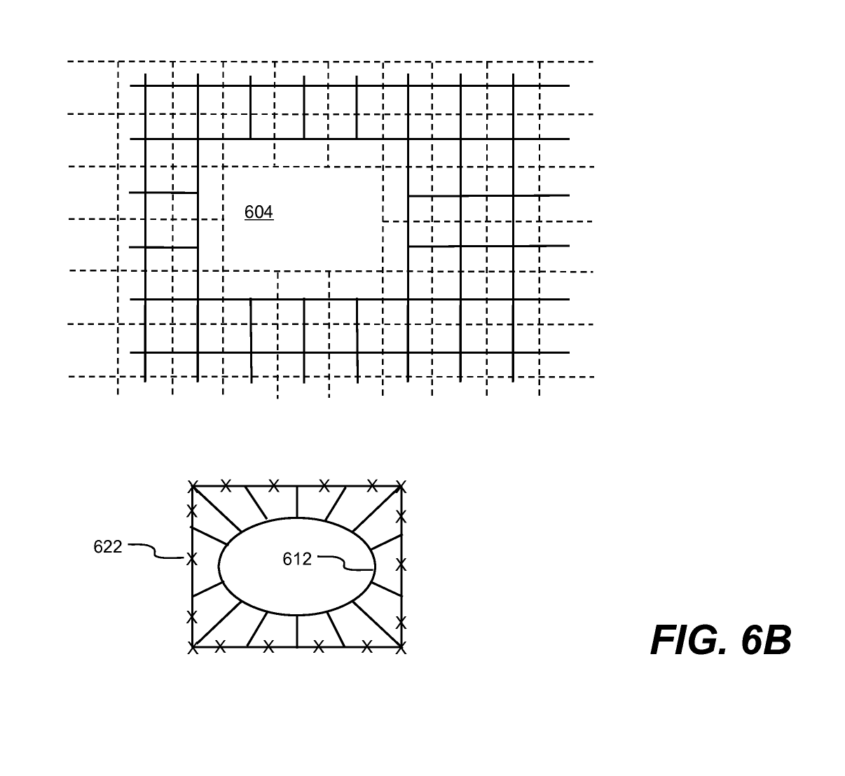

FIGS. 6A-6B shows an exemplary computerized model created from joining NURBS patches together using process 100 in accordance with an embodiment of the present invention. In this example, a regular patch with a hole is created.

First, a regular NURBS patch 602 without hole 610 is defined. Then a set of “elements” 604 where the hole 610 is located are removed. Finally, a set of patches 612 around the hole 610 are defined and tied to the patch with the set of elements removed along the boundary. The “X”s along the boundary represent the control points 622. Tying up two patches can be done with the process 100 shown in FIGS. 1A-1C.

Referring now to FIGS. 7A-7F, there are shown two exemplary imperfectly-matching NURBS patches (“Patch-1” 701 and “Patch-2” 702) joined together along a physical boundary (“Common Curve” 715) to form a computerized model suitable for FEA. “Common Curve” 715 is an overlapped section between a first curve “Curve-1” 711 and a second curve “Curve-2” 712. “Curve-1” 711 and “Curve-2” 712 are respective boundary curves of “Patch-1” 701 and “Patch-2” 702. Further, “Curve-1” 711 is defined by control points (P₀¹, P₁¹, P₂¹, P₃¹, P₄¹, P₅¹, P₆¹, P₇¹), while “Curve-2” is defined by control points (P₀¹, P₁², P₂², P₃², P₄², P₅², P₆², P₇²).

All of the curves are NURBS curves defined by control points, knot-vector, polynomial order and weights at control points. A typical p′-degree NURBS curve is defined in Equation (1) as follows:

$$C ( u ) = \frac{{\sum }_{i = 0}^{n} {N}_{i , p} ( u ) {w}_{i} {P}_{i}}{{\sum }_{i = 0}^{n} {N}_{i , p} ( u ) {w}_{i}} \qquad ( 1 )$$

where:
(n+1) is number of control points,
(m+1) is the number of knots (m=n+p+1),
Pᵢ is control point,
wᵢ is weight at control point Pᵢ,
p is polynomial order (degree) of the curve,
U(u₀, u₁, . . . , uₘ) is knot-vector, which contains non-decreasing sequence of real numbers,
N_{i,p}(u) is p^{th}-degree B-spline basis function (defined recursively),

$${N}_{i , 0} ( u ) = \{ \begin{matrix}1 , & if ( {u}_{i} \leq u < {u}_{i + 1} ) \\ 0 , & otherwise\end{matrix} \\ {N}_{i , p} ( u ) = \frac{u - {u}_{i}}{{u}_{i + p} - {u}_{i}} {N}_{i , p - 1} ( u ) + \frac{{u}_{i + p + 1} - u}{{u}_{i + p + 1} - {u}_{i + 1}} {N}_{i + 1 , p - 1} ( u )$$

The curves are then normalized such that the parametric length equals the physical length. To compute the length L 720 of a NURBS curve 710 shown in FIG. 7B, the following equations (2)-(4) are used.

L=∫ᵤ_{₀₊ₚ}^{u}^{_{m−p}}|C′(u)|du=∫ᵤ_{₀₊ₚ}^{u}^{₀₊ₚ₊₁}|C′(u)|du+ . . . +∫ᵢ_{_{m−1+p}}^{u}^{_{m−p}}|C′(u)|du (2)

L=Lₚ+ . . . +Lₘ₋₁₋ₚ (3)

Lᵢ=∫ᵤ_{_{i−1+p}}^{u}^{ᵢ₊ₚ}|C′(u)|du (4)

Once respective arc lengths of the two curves (i.e., “Curve-1” 711 and “Curve-2” 712) are computed, the two knot-vectors are scaled and shifted. For example, an initial knot-vector of a curve is listed as U=(a, . . . , a, uₚ₊₁, . . . , uₘ₋ₚ₋₁, b, . . . , b).

There are (p+1) terms of “a” and “b”. The arc length is calculated using Equation (5).

L=∫ₐ^{b}|C′(u)|du (5)

Normalized knot-vector of U is Ũ=(0, . . . , 0, ũₚ₊₁, . . . , ũₘ₋ₚ₋₁, L, . . . , L) with

$${\tilde{u}}_{i} = ( {u}_{i} - a ) \frac{L}{b - a} .$$

Referring now to FIG. 7C, it is shown projection points \hat{P}ₐ¹ and \hat{P}_{b}² on “Curve-1” 711 and “Curve-2” 712, respectively. These two points mark the beginning and end of the overlapped section (or common curve 715). To shift the normalized knot-vector in such a way, that 0 is at \hat{P}ₐ¹ and Lₑ=b₁=a₂ at \hat{P}_{b}². Lₑ is the arc length of the common curve 715. In this example, only the normalized knot-vector of “Curve-1” 711 is shifted by “−a₁”. As a result, respective knot-vectors Û⁽¹⁾ and Û⁽²⁾ of “Curve-1” 711 and “Curve-2” 712 are listed below:

Û⁽¹⁾=(−a₁, . . . ,−a₁,ũₚ₊₁⁽¹⁾, . . . ,ũₘ_{₁}₋ₚ₋₁,L₁−a₁, . . . ,L₁−a₁)

Ũ⁽²⁾=Ũ⁽²⁾=(0, . . . ,0,ũₚ₊₁⁽²⁾, . . . ,ũₘ_{₂}₋ₚ₋₁,L₂, . . . ,L₂)

Next, the curve having fewer control points along the overlapped section (common curve 715) is designated as master curve. The other curve is designated as slave curve. In the example shown in FIG. 7D, “Curve-1” 711 is designated as slave curve while “Curve-2” 712 as master curve, because there are four control points along the overlapped section 715 of “Curve-2” 712 and six control points in “Curve-1” 711.

Knot-vector of “Curve-1” 711 is Û⁽¹⁾=(â⁽¹⁾, . . . , â⁽¹⁾, ûₚ₊₁⁽¹⁾, . . . , ûₘ_{₁}₋ₚ₋₁⁽¹⁾, \hat{b}⁽¹⁾, . . . , \hat{b}⁽¹⁾).
Knot-vector of “Curve-2” 712 is Û⁽²⁾=(â⁽²⁾, . . . , â⁽²⁾, ûₚ₊₁⁽²⁾, . . . , ûₘ_{₂}₋ₚ₋₁⁽²⁾, \hat{b}⁽²⁾, . . . , \hat{b}⁽²⁾).

In determining the dependencies between the control points of “Curve-1” 711 and “Curve-2” 712, knot insertion operations are performed in the slave curve and in the master curve. As a result, the master and the slave curves share the same knot-vector along the overlapped section (or common curve 715) shown in FIG. 7E. For the first curve “Curve-1” 711, control points are P⁽¹⁾=(P₀¹, P₁¹, P₂¹, P₃¹, P₄¹, P₅¹, P₆¹, P₇¹). For the second curve “Curve-2” 712 control points are P⁽²⁾=(P₀², P₁², P₂², P₃², P₄², P₅², P₆², P₇²).

In other words, for “Curve-1” 711, missing knots are inserted and P^{(c)} are computed depending upon P⁽¹⁾. For “Curve-2” 712, missing knots are inserted also, and P^{(c)} are computed depending upon P⁽²⁾. And control points in the overlapped section are P^{(c)}=P⁽¹⁾=(P₀^{c}, P₁^{c}, P₂^{c}, P₃^{c}, P₄^{c}, P₅^{c}, P₆^{c}, P₇^{c}). The dependencies between control points of “Curve-1” 711 and “Curve-2” 712 are computed using pseudo-inverse of S shown in FIG. 7F.

Further, the method for a knot insertion operation is shown in the following example:

Knot ūε[uₖ, uₖ₊₁] is inserted in a knot-vector u=[u₁, u₂, . . . , uₘ].
A ratio is then calculated as follows: for k.

$${α}_{i} = \frac{\overline{u} - {u}_{i}}{{u}_{i + p} - {u}_{i}}$$

for k−0+1≦i≦k.
Then the weighted control point Qᵢ^{w}=(1−αᵢ)Pᵢ₋₁^{w}+αᵢP^{w} is inserted as follows:

Q₁^{w}=P₁^{w}

.

.

Qₖ₋ₚ²=P₋ₚ^{w}

Qₖ₋ₚ^{w}=Pₖ₋ₚ^{w}

Qᵢ^{w}=(1−αᵢ)Pᵢ₌₁^{w}+αᵢPᵢ^{w}

Qₖ^{w}=Pₖ^{w}

.

.

Qₘ₊₁^{w}=Pₘ^{w}

For this the definition of the four-dimensional weighted control points has been used. Given a set of control points Pᵢ and weights wᵢ the weighted control points are defined with: Pᵢ^{w}=(wᵢxᵢ, wᵢyᵢ, wᵢzᵢ, wᵢ).

According to one aspect, the present invention is directed towards one or more computer systems capable of carrying out the functionality described herein. An example of a computer system 800 is shown in FIG. 8. The computer system 800 includes one or more processors, such as processor 804. The processor 804 is connected to a computer system internal communication bus 802. Various software embodiments are described in terms of this exemplary computer system. After reading this description, it will become apparent to a person skilled in the relevant art(s) how to implement the invention using other computer systems and/or computer architectures.

Computer system 800 also includes a main memory 808, preferably random access memory (RAM), and may also include a secondary memory 810. The secondary memory 810 may include, for example, one or more hard disk drives 812 and/or one or more removable storage drives 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc. which is read by and written to by removable storage drive 814. As will be appreciated, the removable storage unit 818 includes a computer usable storage medium having stored therein computer software and/or data.

In alternative embodiments, secondary memory 810 may include other similar means for allowing computer programs or other instructions to be loaded into computer system 800. Such means may include, for example, a removable storage unit 822 and an interface 820. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 822 and interfaces 820 which allow software and data to be transferred from the removable storage unit 822 to computer system 800. In general, Computer system 800 is controlled and coordinated by operating system (OS) software, which performs tasks such as process scheduling, memory management, networking and I/O services.

There may also be a communications interface 824 connecting to the bus 802. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824. The computer 800 communicates with other computing devices over a data network based on a special set of rules (i.e., a protocol). One of the common protocols is TCP/IP (Transmission Control Protocol/Internet Protocol) commonly used in the Internet. In general, the communication interface 824 manages the assembling of a data file into smaller packets that are transmitted over the data network or reassembles received packets into the original data file. In addition, the communication interface 824 handles the address part of each packet so that it gets to the right destination or intercepts packets destined for the computer 800. In this document, the terms “computer program medium”, “computer readable storage medium”, “computer recordable medium” and “computer usable medium” are used to generally refer to media such as removable storage drive 814 (e.g., flash storage drive), and/or a hard disk installed in hard disk drive 812. These computer program products are means for providing software to computer system 800. The invention is directed to such computer program products.

The computer system 800 may also include an input/output (I/O) interface 830, which provides the computer system 800 to access monitor, keyboard, mouse, printer, scanner, plotter, and the likes.

Computer programs (also called computer control logic) are stored as application modules 806 in main memory 808 and/or secondary memory 810. Computer programs may also be received via communications interface 824. Such computer programs, when executed, enable the computer system 800 to perform the features of the present invention as discussed herein. In particular, the computer programs, when executed, enable the processor 804 to perform features of the present invention. Accordingly, such computer programs represent controllers of the computer system 800.

In an embodiment where the invention is implemented using software, the software may be stored in a computer program product and loaded into computer system 800 using removable storage drive 814, hard drive 812, or communications interface 824. The application module 806, when executed by the processor 804, causes the processor 804 to perform the functions of the invention as described herein.

The main memory 808 may be loaded with one or more application modules 806 that can be executed by one or more processors 804 with or without a user input through the I/O interface 830 to achieve desired tasks. In operation, when at least one processor 804 executes one of the application modules 806, the results are computed and stored in the secondary memory 810 (i.e., hard disk drive 812). Results of the computation (e.g., dependencies of the master and the slave curves) are reported to the user via the I/O interface 830 either in a text or in a graphical representation upon user's instructions.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas first and second NURBS patches have been shown with rectangular plan view, other shapes may be used in the present invention to achieve the same. Further, whereas FIGS. 5A-5C shows an arbitrarily simplified example, the present invention does not set limit as to the number of control points/knot-vector values in any NURBS patch/curve. In summary, the scope of the invention should not be restricted to the specific exemplary embodiments disclosed herein, and all modifications that are readily suggested to those of ordinary skill in the art should be included within the spirit and purview of this application and scope of the appended claims

What is claimed is:

1. A method of joining imperfectly-matching Non-Uniform Rational Basis Splines (NURBS) patches to form a computerized model suitable for finite element analysis (FEA), said method comprising:
receiving, in a computer system having an application module installed thereon, definitions of a first NURBS patch and a second NURBS patch, the first and second NURBS patches to be joined together along a physical boundary defined in a first curve with a first set of control points, associated weights and a corresponding first plurality of knot-vector values in the first NURBS patch and defined in a second curve with a second set of control points, associated weights and a corresponding second plurality of knot-vector values in the second NURBS patch, wherein the first set of control points and said first plurality of knot-vector values are different from the second set of control points and said second plurality of knot-vector values;
normalizing said first plurality of knot-vector values such that the first curve's parametric length equals the first curve's physical length in the first NURBS patch;
normalizing said second plurality of knot-vector values such that the second curve's parametric length equals the second curve's physical length in the second NURBS patch;
determining a common curve as an overlapped section of the first and the second curves to represent the physical boundary;
adjusting the first and the second curves such that first and second projection points correspond to starting and end locations of the common curve, respectively;
designating one of the first and second curves having less number of control points along the common curve as a master curve, the other as a slave curve; and
determining a set of linear constraint equations for numerically connecting the first and second NURBS patches along the physical boundary by computing dependencies of the slave curve's control points to the master curve's control points, whereby the first and second NURBS patches together with the set of linear constraint equations for the control points along the physical boundary enable a computerized model created therefrom suitable for finite element analysis.

2. The method of claim 1, said computing dependencies of the slave curve's control points to the master curve's control points further comprising:
determining a first dependency relationship by a first set of knot insertion operations from the common curve to the slave curve;
determining a second dependency relationship by a second set of knot insertion operations from the common curve to the master curve; and
computing the set of linear constraint equations from the first and the second dependency relationships.

3. The method of claim 1, wherein the set of linear constraint equations numerically constraints nodal displacements of the slave curve's control points to be dependent upon nodal displacements of the master's curve's control points in the computerized model.

4. The method of claim 1, wherein the application module is used for creating the computerized model.

5. The method of claim 1, wherein the physical boundary is specified by a user.

6. The method of claim 5, wherein the first curve and the second curve are substantially similar within a tolerance measuring from the physical boundary.

7. A system for joining imperfectly-matching Non-Uniform Rational Basis Splines (NURBS) patches to form a computerized model suitable for finite element analysis (FEA), the system comprises:
an input/output (I/O) interface;
a memory for storing computer readable code for an application module;
at least one processor coupled to the memory, said at least one processor executing the computer readable code in the memory to cause the application module to perform operations of:
receiving definitions of a first NURBS patch and a second NURBS patch, the first and second NURBS patches to be joined together along a physical boundary defined in a first curve with a first set of control points, associated weights and a corresponding first plurality of knot-vector values in the first NURBS patch and defined in a second curve with a second set of control points, associated weights and a corresponding second plurality of knot-vector values in the second NURBS patch, wherein the first set of control points and said first plurality of knot-vector values are different from the second set of control points and said second plurality of knot-vector values;
normalizing said first plurality of knot-vector values such that the first curve's parametric length equals the first curve's physical length in the first NURBS patch;
normalizing said second plurality of knot-vector values such that the second curve's parametric length equals the second curve's physical length in the second NURBS patch;
determining a common curve as an overlapped section of the first and the second curves to represent the physical boundary;
adjusting the first and the second curves such that first and second projection points correspond to starting and end locations of the common curve, respectively;
designating one of the first and second curves having less number of control points along the common curve as a master curve, the other as a slave curve; and
determining a set of linear constraint equations for numerically connecting the first and second NURBS patches along the physical boundary by computing dependencies of the slave curve's control points to the master curve's control points, whereby the first and second NURBS patches together with the set of linear constraint equations for the control points along the physical boundary enable a computerized model created therefrom suitable for finite element analysis.

8. The system of claim 7, said computing dependencies of the slave curve's control points to the master curve's control points further comprising:
determining a first dependency relationship by a first set of knot insertion operations from the common curve to the slave curve;
determining a second dependency relationship by a second set of knot insertion operations from the common curve to the master curve; and
computing the set of linear constraint equations from the first and the second dependency relationships.

9. The system of claim 7, wherein the set of linear constraint equations numerically constraints nodal displacements of the slave curve's control points to be dependent upon nodal displacements of the master's curve's control points in the computerized model.

10. The system of claim 7, wherein the application module is used for creating the computerized model.

11. The system of claim 7, wherein the physical boundary is specified by a user.

12. The system of claim 11, wherein the first curve and the second curve are substantially similar within a tolerance measuring from the physical boundary.

13. A non-transitory computer readable storage medium containing computer executable instructions for joining imperfectly-matching Non-Uniform Rational Basis Splines (NURBS) patches to form a computerized model suitable for finite element analysis (FEA) by a method comprising:
receiving, in a computer system having an application module installed thereon, definitions of a first NURBS patch and a second NURBS patch, the first and second NURBS patches to be joined together along a physical boundary defined in a first curve with a first set of control points, associated weights and a corresponding first plurality of knot-vector values in the first NURBS patch and defined in a second curve with a second set of control points, associated weights and a corresponding second plurality of knot-vector values in the second NURBS patch, wherein the first set of control points and said first plurality of knot-vector values are different from the second set of control points and said second plurality of knot-vector values;
normalizing said first plurality of knot-vector values such that the first curve's parametric length equals the first curve's physical length in the first NURBS patch;
normalizing said second plurality of knot-vector values such that the second curve's parametric length equals the second curve's physical length in the second NURBS patch;
determining a common curve as an overlapped section of the first and the second curves to represent the physical boundary;
adjusting the first and the second curves such that first and second projection points correspond to starting and end locations of the common curve, respectively;
designating one of the first and second curves having less number of control points along the common curve as a master curve, the other as a slave curve; and
determining a set of linear constraint equations for numerically connecting the first and second NURBS patches along the physical boundary by computing dependencies of the slave curve's control points to the master curve's control points, whereby the first and second NURBS patches together with the set of linear constraint equations for the control points along the physical boundary enable a computerized model created therefrom suitable for finite element analysis.

14. The non-transitory computer readable storage medium of claim 13, said computing dependencies of the slave curve's control points to the master curve's control points further comprising:
determining a first dependency relationship by a first set of knot insertion operations from the common curve to the slave curve;
determining a second dependency relationship by a second set of knot insertion operations from the common curve to the master curve; and
computing the set of linear constraint equations from the first and the second dependency relationships.

15. The non-transitory computer readable storage medium of claim 13, wherein the set of linear constraint equations numerically constraints nodal displacements of the slave curve's control points to be dependent upon nodal displacements of the master's curve's control points in the computerized model.

16. The non-transitory computer readable storage medium of claim 13, wherein the application module is used for creating the computerized model.

17. The non-transitory computer readable storage medium of claim 13, wherein the physical boundary is specified by a user.

18. The non-transitory computer readable storage medium of claim 17, wherein the first curve and the second curve are substantially similar within a tolerance measuring from the physical boundary.
